(19) United States
(12) Patent Application Publication
(10) Pub. No.: US 2007/0154314 A1
(43) Pub. Date: Jul. 5, 2007

(54) Reduction of tonal noise in cooling fans using splitter blades

(75) Inventors: Yousef Jarrah, Tucson, AZ (US); John Herzberger, Tempe, AZ (US); Desi Riedel, Phoenix, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Minebea Co., Ltd., Tokyo (JP)

(21) Appl. No.: 11/642,792

(22) Filed: Dec. 19, 2006

Related U.S. Application Data
(60) Provisional application No. 60/755,474, filed on Dec. 29, 2005.

(51) Int. Cl. B64C 11/16

(52) U.S. Cl. 416/203

(57) ABSTRACT

Disclosed is a hub of an axial fan. The hub includes primary fan blades and splitter blades disposed between pairs of the primary fan blades. The resulting hub has been observed to reduce tonal noise during fan operation.

### CROSS-REFERENCES TO RELATED APPLICATIONS

The present application claims priority from U.S. Provisional Application No. 60/755,474, filed Dec. 29, 2005, and is fully incorporated herein by reference for all purposes.

### BACKGROUND OF THE INVENTION

The present invention relates generally to axial fans and in particular to a configuration of fan blades to reduce noise.

FIG. 4 shows an exploded cross-sectional view of components comprising a conventional axial fan. The figure shows a base 402 that is part of the cooling fan housing (not shown) onto which a stator is mounted. Typically, the base 402 includes a small printed circuit board for the electronics which control motor operation. Power and control wires (not shown) run from the printed circuit board for connection to an external power source and to a computer. The stator assembly comprises a coil subassembly 404 comprising some number of individually activated coils wound about a bearing liner 406. A rotor assembly is positioned around the stator coil 404. The rotor assembly includes a yoke 408 which is shaped like a cup that fits around the stator coil 404. An axle 410 is axially connected to the interior of the yoke 408. A number of permanent magnets 412 are fixedly mounted about the interior periphery of the yoke 408. When the yoke 408 is assembled with the stator assembly, the axle 408 is received within the bearing liner 406 and the permanent magnets 412 are disposed around the coil subassembly 404. The axle 410 rests on a bearing surface neat the bottom of the bearing liner 406. An impeller 414, comprising a hub 416 and some number of fan blades 418 attached to the hub, fits over the yoke 408 and is connected to the yoke.

A common problem with fans is the noise they generate during operation. A particularly displeasing noise component is tonal noise. Tonal noise is a result of the rotation of the fan blades. The frequency spectrum of tonal noise comprises largely of components of the blade passing frequency (fundamental and harmonics), which is the number of fan blades times the shaft speed (revolutions per second). Broadband noise is another noise component, but is less noticeable as compared to tonal noise since its frequency spectrum is generally much broader that the frequency spectrum of tonal noise and the amplitudes of its frequency components are lower.

### BRIEF SUMMARY OF THE INVENTION

One embodiment according to the invention alternates the chord length of each blade in order to break up any tonal noise related to the blade passing frequency. For example, on an 8-bladed impeller, four blades are of one chord length and four blades are of another chord length. Varying the length of the chord of the blades with respect to the other blades is a key aspect of the invention. This reduces the tonal noise of the blade passing frequency by changing one strong blade passing frequency into two smaller blade passing frequencies. Other possibilities include an increased number of chord lengths within a fan design.

A result of cooling fans having fan blade configurations according to the present invention is significant reduction of tonal noise due to blade passing frequency.

### BRIEF DESCRIPTION OF THE DRAWINGS

FIG. 1 is an illustration of the hub of an axial fan according to the present invention.

FIG. 1A is an image of a prototype of the hub illustrated in FIG. 1.

FIG. 2 is a schematic view a full blade and splitter blade arrangement according to the present invention.

FIG. 3 is schematic view of a simple embodiment of the present invention.

FIG. 4 is an exploded view of a conventional fan.

FIG. 5 is a diagram of an airfoil, showing various parameters of an airfoil.

### DETAILED DESCRIPTION OF THE INVENTION

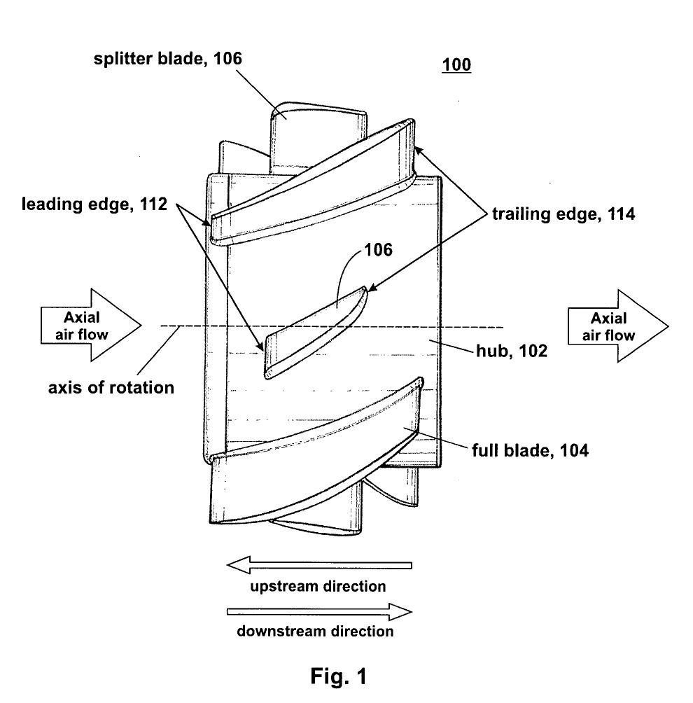

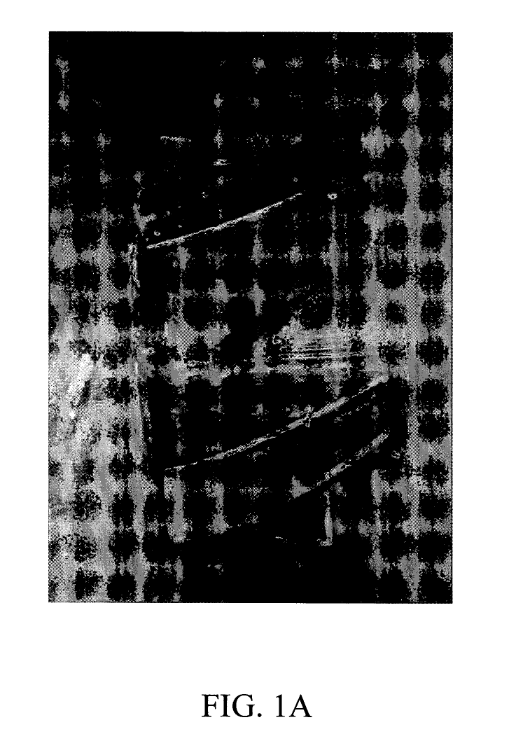

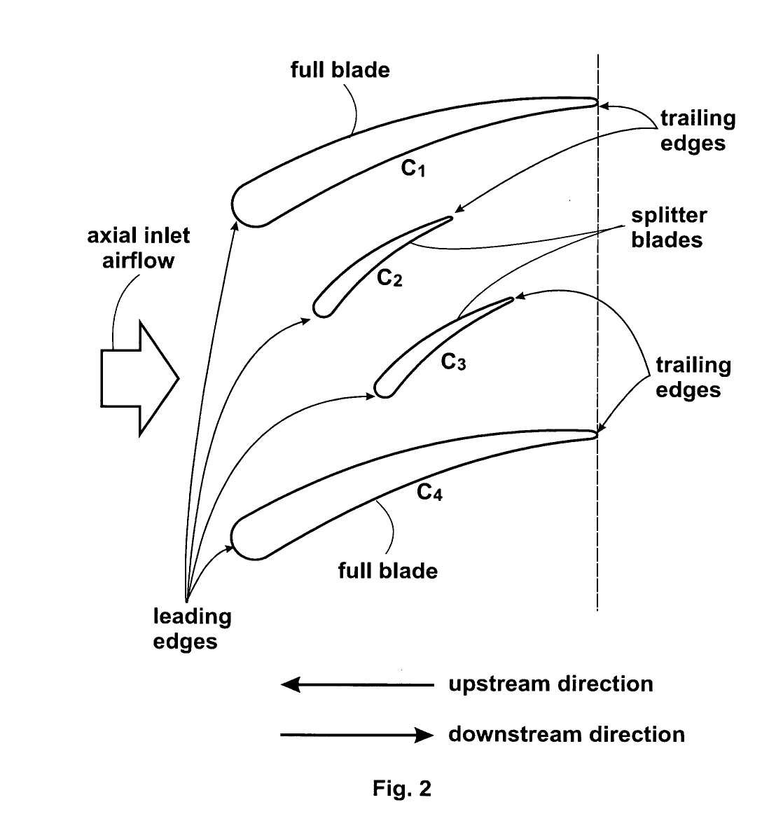

FIG. 1 illustrates an axial impeller 100 made in accordance with the teachings of the present invention. FIG. 1A is a photograph of a prototype of the impeller shown in FIG. 1. The impeller comprises a hub 102. Disposed about the hub 102 is a plurality of fan blades 104, 106. The figure shows what are commonly referred to as “full blades” 104. Disposed between a pair of full blades 104 is what is would be referred to as a “splitter blade” 106. The blades 104, 106 are connected to the hub 102 at the roots of the blades. When the impeller 100 rotates about its axis of rotation, an axial air flow is created, as illustrated by the arrows. In accordance with the present invention, the splitter blades 106 in FIG. 1 are connected to the hub 102 such that their axial position relative to the full blades fall between the leading edges 112 and the trailing edges 114 of the full blades 104. This will be discussed in more detail in FIG. 2.

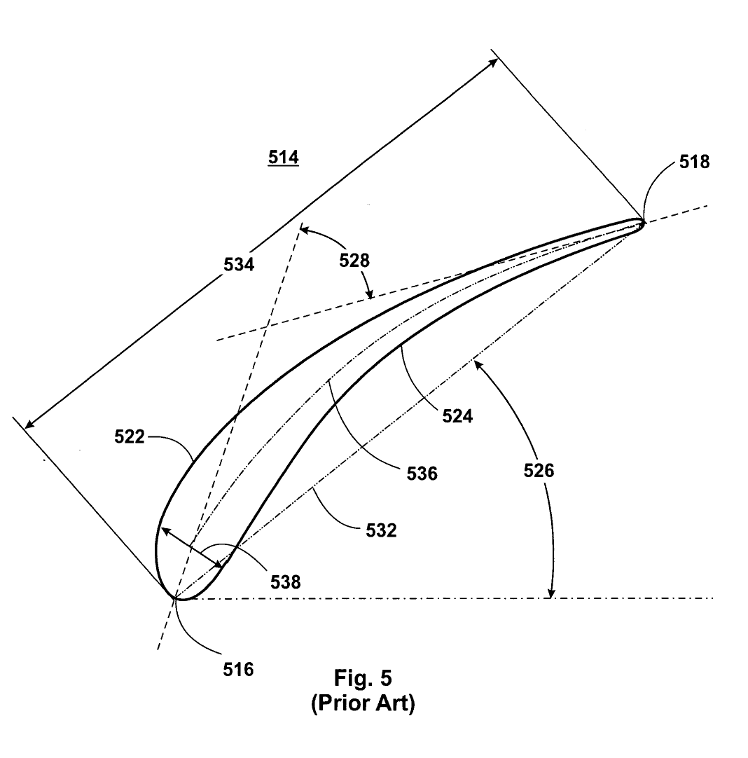

Referring for a moment to FIG. 5, a discussion of the cross-sectional view of a fan blade is given. The figure shows various parameters for fan blades which define, in part, the cross-sectional shape 514 of the fan blade. Each cross-section of the blade (referred to as an airfoil section) has a leading edge 516, a trailing edge 518, an upper surface 522, and a lower surface 524. The cross-section 514 may be further defined by the stagger angle 526, the camber angle 528, a chord line 532, its chord length (denoted by “c”) 534, a mean camber line 536, and a thickness 538 measurement. In prior art fans, the chord length 534 typically is substantially the same for each fan blade comprising the fan.

Continuing with FIG. 2, in accordance with the present invention, two or more splitter blades can be disposed between a pair of full blades. While the embodiment of FIG. 1 shows one splitter blade between a pair of full blades, FIG. 2 shows an example where two splitter blades are provided between a pair of full blades. Of course, additional numbers of such splitter blades may be provided. The chord lengths of the full blades, denoted respectively by c₁ and c₄, are greater than the chord lengths of the splitter blades, denoted respectively by c₂ and c₃.

It is noted that the stagger angle and the camber angle of the splitter blades need not be the same as those of the full blades. In general, the splitter blades can have different stagger angles, camber angles, and chord lengths.

It is further noted that chord lengths c₁, c₄ can be equal or different values. Similarly, the chord lengths c₂, c₃ of the splitter blades can be equal or different values. It is further noted that in the case where full blades have different chord lengths, the full blades should be arranged symmetrically about the hub to which the full blades attach so that their chord lengths are symmetrically distributed about the hub. Similarly, the splitter blades should be arranged about the hub such that their chord lengths are symmetrically distributed about the hub. This symmetrical distribution about the hub ensures that the impeller is balanced so as to avoid wobble during operation of the fan.

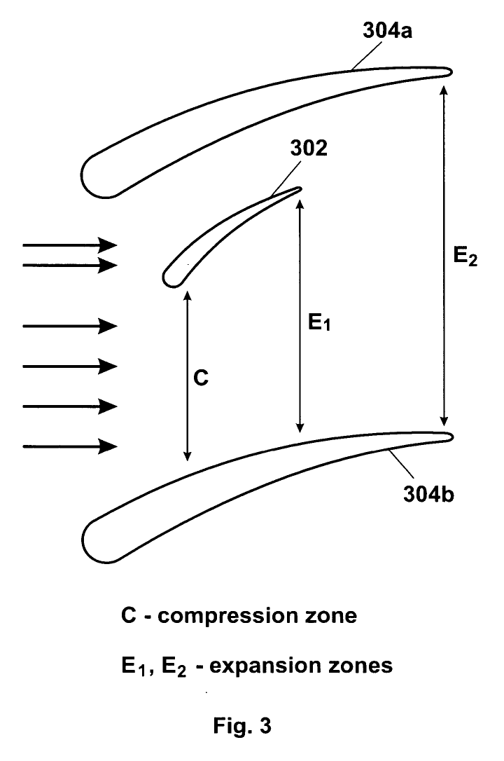

FIG. 3 shows a simple embodiment of the present invention. A single splitter blade 302 is positioned so that the leading edge of the splitter blade is downstream of the leading edges of the corresponding pair of full blades 304a, 304b (collectively 304), and likewise the trailing edge of the splitter blade 302 is upstream of the trailing edges of the full blades 304. As commonly understood, the “upstream” direction refers to a direction pointing into the airflow (shown by the arrows in FIG. 3). Conversely, the “downstream” direction refers to the direction of the airflow. Thus, the splitter blade 302 is disposed between the leading edge of the full blades and the trailing edges of the full blades.

Similarly for the case where there are two or more splitter blades between their associated full blades, such as shown in FIG. 2, the leading edge of each splitter blade is downstream of the leading edges of the associated pair of full blades and the trailing edge of each splitter blade is upstream of the trailing edges of the associated full blades. Stated differently, each splitter blade is disposed between the leading edged of its corresponding full blades and the trailing edges of the corresponding full blades.

Thus in general, the chord length can be the same for each splitter blade, while the other end of the spectrum, the chord length can be different for each splitter blade. In other embodiments, the chord length varies among some of the splitter blades. As noted above, the other parameters (e.g., stagger angle, camber angle) can be fixed or variable among the splitter blades. In some embodiments, the number of splitter blades between each pair of full blades is the same. In other embodiments, the number of splitter blades between a pair of full blades varies from pair to pair. It is noted that the splitter blades should be arranged about the hub in symmetric fashion. For example, if the number of splitter blades between pairs of full blades varies, that number should vary in a symmetric manner about the hub.

In accordance with the present invention, the splitter blades create area compression zones and area expansion zones between a pair of full blades. These compression and expansion zones serve to reduce blade passing noise of the airflow (acoustic wave). Referring to FIG. 3, an axially directed airflow is shown by the arrows. It will be understood that as the airflow passes between the pair of full blades 304, the airflow splits into two flows when it encounters the splitter blade 302. The acoustic wave of the lower component of the airflow (as shown in FIG. 3) which passes between the splitter blade 302 and the full blade 304b is subject to area compression in a compression zone C (i.e., the cross-sectional area is reduced). As the airflow continues in the downstream direction, the spacing between the splitter blade 302 and the full blade 304b increases, thus creating an area expansion zone (i.e., the cross-sectional area expands). The acoustic wave expands into this area expansion zone El and as a result of the expansion, the energy in the acoustic wave is reduced and consequently the noise is reduced. As can be seen in FIG. 3, the a second expansion zone E₂ is the area expansion zone created by the pair of full blades 304a, 304b.

As indicated above, the chord length can the same for each splitter blade, while the other end of the spectrum, the chord length can be different for each splitter blade. In other embodiments, the chord length varies among some of the splitter blades. In some embodiments, the number of splitter blades between each pair of full blades is the same. In other embodiments, the number of splitter blades between a pair of full blades varies from pair to pair. It is noted that the splitter blades should be arranged about the hub in symmetric fashion. For example, if the number of splitter blades between pairs of full blades varies, that number should vary in a symmetric manner about the hub.

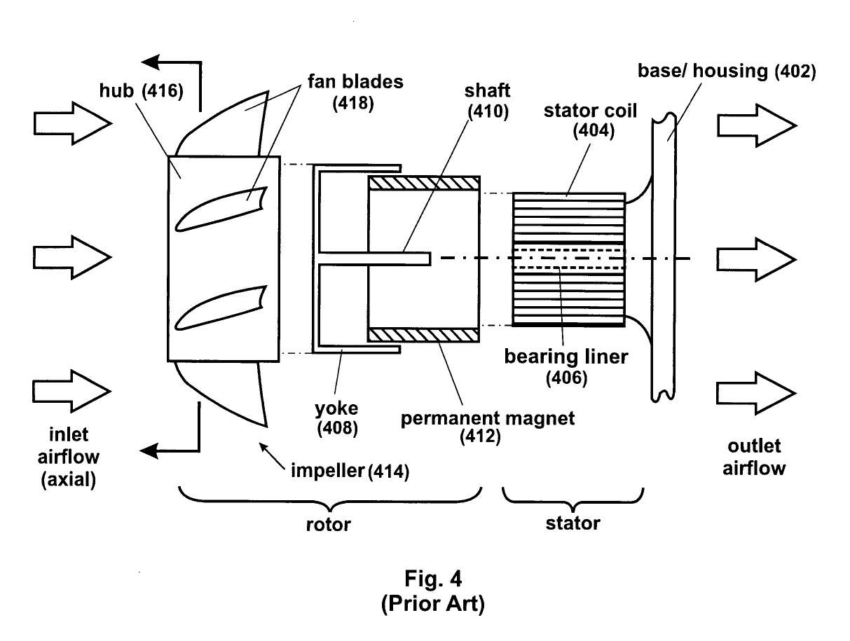

A fan embodiment according to the present invention can be obtained by replacing the hub 416 shown in FIG. 4 with the hub 102 shown in FIG. 1. An alternate hub configuration is illustrated in FIG. 2 where two splitter blades are disposed between a pair of full blades.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An axial fan comprising:
an impeller configured to produce axial airflow when it is driven by a motor to rotate about an axis of rotation,
the impeller comprising:
a hub;
a plurality of primary blades disposed about the hub; and
a plurality of secondary blades disposed about the hub,
the chord lengths of the secondary blades being shorter that the chord lengths of the primary blades,
at least one secondary blade being disposed between the leading edge and the trailing edge of the primary blades.

2. The fan of claim 1 wherein the leading edge of the at least one secondary blade is downstream of the leading edges of the primary blades.

3. The fan of claim 1 wherein one of the primary blades and one of the secondary blades together form a compression zone and an expansion zone, the expansion zone being downstream of the compression zone.

4. The fan of claim 1 wherein the trailing edges of the at least one secondary blade is upstream of the trailing edges of the primary blades.

5. A fan for axial airflow comprising an impeller and a motor connected to the impeller, the impeller comprising:
a hub;
at least a pair of primary fan blades; and
one or more secondary fan blades disposed between the pair of primary blades and aligned relative to the pair of primary blades,
wherein one of the primary fan blades and one of the secondary fan blades defines an expansion zone.

6. The cooling fan of claim 8 wherein the chord length of the splitter fan blades are less than the chord lengths of at least some of the primary fan blades.

7. The cooling fan of claim 8 wherein the chord lengths of splitter fan blades between a first pair of the primary fan blades is less that the chord lengths of the first pair of primary fan blades.

8. The cooling fan of claim 5 wherein the leading edges of the one or more of the secondary fan blades are downstream of the leading edges of the pair of primary blades.

9. The cooling fan of claim 8 wherein the trailing edges of the one or more secondary fan are upstream of the trailing edges of the pair of primary blades.

10. A fan assembly comprising:
a drive device;
a hub member coupled to the drive device wherein the hub is rotated about an axis of rotation by the drive device;
a plurality of main blade members operably coupled to the hub member, the plurality of main blade members being adapted to capture an axially directed airflow at an inlet and output the axially directed airflow at an outlet, each of the main blade members having a leading edge and a trailing edge;
one or more splitter blades disposed between at least a pair of the plurality of main blade members, the splitter blade being spatially disposed between the leading edge and the trailing edge, one the splitter blade member having a splitter blade leading edge and a splitter blade tailing edge; and
an area compression region and an area expansion region between each pair of main blade members, the area compression region proximate the splitter blade leading edge, the area expansion region proximate the splitter blade trailing edge.

11. The fan assembly of claim 10 wherein the area compression region and the area expansion region cause a reduction in acoustic energy relative solely with an operation of the plurality of main blade members.

12. The fan assembly of claim 10 wherein the splitter blade trailing edge is upstream of the trailing edge of the main blade member.

13. The fan assembly of claim 10 wherein the splitter blade is one among a plurality of splitter blades.

14. The fan assembly of claim 10 further comprising a second compression region and a second expansion region.

15. The fan assembly of claim 10 wherein the area compression region and the area expansion region are within a spatial region of the hub member.

16. An axial airflow fan comprising an impeller that is rotated about an axis of rotation by a motor to produce an airflow, the impeller comprising:
first fan blades; and
means for creating a region of compression between and downstream of a first pair of the first fan blades and for creating a region of expansion between and upstream of the first pair of the first fan blades,
wherein a portion of the airflow that is captured by the first pair of the first blades is compressed within the region of compression,
wherein the portion of the airflow that was compressed in the region of compression expands when it enters the region of expansion.
